(19) United States
(12) Patent Application Publication
(10) Pub. No.: US 2025/0046819 A1
(43) Pub. Date: Feb. 6, 2025

(54) THERMOSET BINDER AND CERAMIC PARTICLES COATING ON ANODE SURFACE TO ENHANCE STABILITY OF LITHIUM-ION BATTERIES

(71) Applicant: FORD GLOBAL TECHNOLOGIES, LLC, Dearborn, MI (US)

(72) Inventors: Insik JEON, Novi, MI (US); Michael LERNER, Corvallis, OR (US); Feng LI, Troy, MI (US); Wei XU, Livonia, MI (US); Jonghwan PARK, Ann Arbor, MI (US)

(73) Assignee: FORD GLOBAL TECHNOLOGIES, LLC, Dearborn, MI (US)

(21) Appl. No.: 18/228,710

(22) Filed: Aug. 1, 2023

(51) Int. Cl. H01M 4/62; H01M 4/04; H01M 4/134; H01M 4/1395; H01M 10/0525

(52) U.S. Cl. CPC H01M 4/623; H01M 4/0404; H01M 4/134; H01M 4/1395; H01M 10/0525; H01M 2004/021; H01M 2004/027

(57) ABSTRACT

A negative electrode for a lithium-ion battery includes a negative electrode current collector, a negative electrode active layer disposed over the negative electrode current collector, and a ceramic particle-containing layer disposed over the negative electrode active layer. The negative electrode active layer is composed of negative electrode active material. Advantageously, the ceramic particle-containing layer is composed of ceramic particles and a binder where the binder is composed of the residues of cross-linkable monomers.

### TECHNICAL FIELD

In at least one aspect, negative electrode active materials for rechargeable lithium-ion batteries are provided.

### BACKGROUND

Lithium-ion batteries are composed of an anode, a cathode, an electrolyte, and a separator. Anodes are mainly composed of graphite, where lithium-ion is intercalated into the graphite layers in the course of the charging process. In the initial charging step, an SEI (solid electrolyte interface) layer is created on the anode surface and protects the electrolyte from reductive decomposition. It may be desirable to have a stable SEI layer.

Accordingly, there is a need for improved negative electrodes for lithium-ion batteries.

### SUMMARY

In at least one aspect, a negative electrode for a lithium-ion battery is provided. The negative electrode includes a negative electrode current collector, a negative electrode active layer disposed over the negative electrode current collector, and a ceramic particle-containing layer disposed over the negative electrode active layer. The negative electrode active layer is composed of negative electrode active material. Advantageously, the ceramic particle-containing layer is composed of ceramic particles and a binder where the binder is composed of the residues of cross-linkable monomers (e.g., cross-linkable monomers that form cross-links during cell processing).

In another aspect, a rechargeable lithium-ion battery is provided. The rechargeable lithium-ion battery includes at least one lithium-ion battery cell. Each lithium-ion battery cell includes a negative electrode current collector, a negative electrode active layer disposed over the negative electrode current collector, and a ceramic particle-containing layer disposed over the negative electrode active layer. The negative electrode active layer is composed of negative electrode active material. Advantageously, the ceramic particle-containing layer is composed of ceramic particles and a binder where the binder is composed of the residues of cross-linkable monomers. Each lithium-ion battery cell also includes a positive electrode having a positive active material and an electrolyte contacting the negative electrode and the positive electrode.

In another aspect, a method to introduce ceramic particles coating layer on a negative electrode surface employing cross-linkable (thermoset) binders to enhance anode thermal stability is provided. The cross-linkable (thermoset) binders proceed to crosslink under the curing process and provide robust ceramic layer on the negative electrode surface. Typically, the thermoset ceramic layer via thermo-, UV-, or E-beam in the presence of radical initiators (e.g., peroxides (BPO, AIBN, phosphorus compounds, or sulfates, etc).

In another aspect, an additional ceramic particles layer coating negative electrode surface could protect SEI layer, mitigate lithium deposit and hinder dendrite growth (higher tortuosity), improve anode electrolyte wetting for uniformed current density. Also, it offers thermally conductive layer that could dissipate isolated heat created from hot spot by either soft or hard short-circuit. These benefits are only valid when the melting point of binder in the ceramic layer is within the range preventing thermal runaway.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A. Schematic cross-section of a negative electrode that includes negative active electrode material on a single side of a current collector.

FIG. 1B. Schematic cross-section of a negative electrode that includes negative active electrode material on both sides of a current collector.

FIG. 2. Schematic cross-section of a battery cell that includes the negative electrode of FIG. 1A.

FIG. 3. Schematic cross-section of a battery pack that includes the battery cells of FIG. 2.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “comprising.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

A “thermoset polymer” refers to a type of polymer that undergoes a chemical reaction during its curing process, resulting in a cross-linked three-dimensional network structure.

The term “residue”, means a portion, and typically a major portion, of a molecular entity, such as a molecule, or a part of a molecule such as a group, which has underwent a chemical reaction and is now covalently linked to another molecular entity. In a refinement, the term “residue,” when used in reference to a monomer or monomer unit means the remainder of the monomer unit after the monomer unit has been incorporated into a polymer structure, such as a binder.

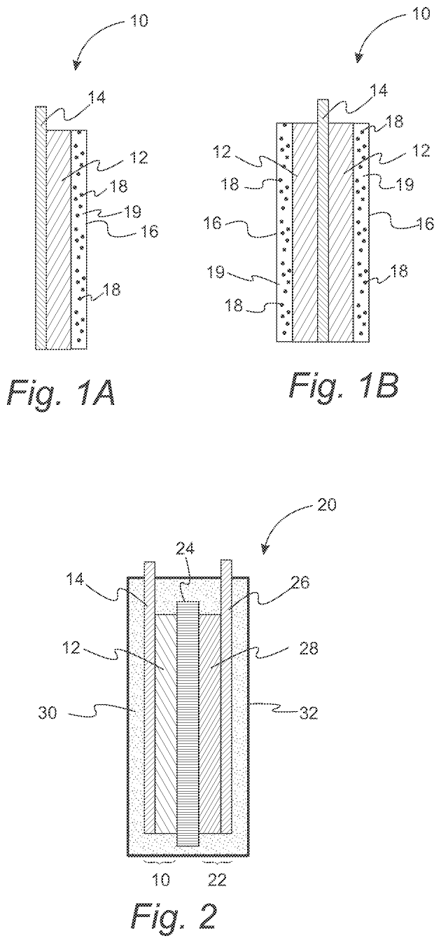

Referring to FIGS. 1A and 1B, a schematic of a negative electrode that includes a negative electrode active material coated with a ceramic particle-containing layer is provided. Negative electrode 10 includes negative electrode active layer 12 that includes negative electrode active material disposed over and typically contacting negative electrode current collector 14. Typically, negative electrode current collector 14 is a metal plate or metal foil composed of a metal such as aluminum, copper, platinum, zinc, titanium, and the like. Currently, copper is most commonly used for the negative electrode current collector. Ceramic particle-containing layer 16 is disposed over, and typically contacts, the negative electrode active layer 12. Characteristically, the ceramic particle-containing layer 16 is composed of ceramic particles 18 and a thermoset binder 19. The thermoset binder is typically composed of the residues of cross-linkable monomers (e.g., cross-linkable monomers that form cross-links during cell processing). In a variation, ceramic particle-containing layer 16 has a thickness from about 0.1 microns to about 30 microns. In a refinement, ceramic particle-containing layer 16 has a thickness from about 0.3 microns to about 10 microns. Examples of ceramic particles include but are not limited to, barium titanate (i.e., BaTiO₃), alumina, boehmite, zirconia, magnesia, boron nitride, silicon carbide, titania, silica, and combinations thereof. Typically, the ceramic particles have an average size from about 0.1 microns and 10 microns. In a refinement, the ceramic particles have an average size from about 0.2 microns to 2 microns.

In a variation, the ceramic particles are present in an amount from about 80 weight percent to about 99.9 weight percent of the combined weight of the ceramic particles and the thermoset binder. In a refinement, the thermoset binder is present in an amount from about 0.1 weight percent to about 20 weight percent of the combined weight of the ceramic particles

In a variation, the cross-linkable monomers include multi-functional moieties. In a refinement, the thermoset binder is composed of a component selected from the group consisting of acrylic polymers, vinylic polymers, epoxy polymers, urethane, fluoropolymers, polyesters, polyimides, and a combination thereof. Additional examples of thermoset binders include but are not limited to, phenolic resins, polyurethanes, unsaturated polyester resins, melamine formaldehyde resins, silicone resins, and combinations thereof. Epoxy resins are formed through the reaction of epoxy monomers with a curing agent or hardener, which results in a chemical cross-linking process called polymerization. Examples of epoxy monomers include bisphenol A diglycidyl ether, bisphenol f diglycidyl ether, novolac epoxy. Examples of curing agents include aliphatic amines (e.g., triethylenetetramine, diethylenetriamine) and aromatic amines (e.g., m-phenylenediamine), polyamides (e.g., reaction product of a polymeric fatty acid with a polyamine, anhydrides (e.g., methylhexahydrophthalic anhydride and nadic methyl anhydride), phenolic curing agents (e.g., phenol-formaldehyde resin), and the like. Polyurethanes are a type of thermoset polymer formed from the reaction product of polyols and isocyanates. Examples of isocyantes include toluene diisocyanate, diphenylmethane diisocyanate, hexamethylene diisocyanate, isophorone diisocyanate, and the like. Examples of polyols include polyester polyols, polyether polyols, polycaprolactone polyols, acrylic polyols, and the like. Unsaturated polyester resins are formed by the reaction of unsaturated dibasic acids or anhydrides with diols or polyols. Melamine formaldehyde resins are a type of thermoset polymer formed from the condensation reaction of melamine and formaldehyde. Silicone resins are a type of thermoset polymer formed from hydrolysis and condensation of organosilanes and/or organosiloxanes.

In a variation, a method for making a negative electrode 10 of FIGS. 1A and 1B is provided. The method includes a step of preparing a negative active material composition by mixing a negative electrode active material, a binder, and a solvent. Negative electrode current collector 14 is coated with the negative active material composition to form an uncured negative electrode active layer. The uncured negative electrode active layer is cured and/or dried to form a cured negative electrode active layer. A reactive mixture that includes ceramic particles and cross-linkable monomers is formed. The cured negative electrode active layer is coated with the reactive mixture to form a thermoset ceramic layer. The thermoset ceramic layer is cured to form a ceramic particle-containing layer. In a refinement, the reactive mixture further includes a radical initiator. The thermoset ceramic layer can be cured thermally, by UV light, or with an E-beam. Examples of radical initiators include but are not limited to peroxides (BPO, AIBN, etc.), phosphorus compounds, or sulfates. Additional details of the composition and formation of the negative electrode active layer 12 and the negative electrode current collector 14 are set forth below.

With reference to FIG. 2, a schematic of a rechargeable lithium-ion battery cell incorporating the negative electrode of FIG. 1 is provided. Battery cell 20 includes negative electrode 10 as described above, positive electrode 22, and separator 24 interposed between the negative electrode and the positive electrode. Positive electrode 22 includes a positive electrode current collector 26 and a positive active material 28 disposed over and typically contacting the positive current collector. Typically, positive electrode current collector 26 is a metal plate or metal foil composed of a metal such as aluminum, copper, platinum, zinc, titanium, and the like. Currently, aluminum is most commonly used for the positive electrode current collector. The battery cell is immersed in electrolyte 30 which is enclosed by battery cell case 32. Electrolyte 30 imbibes into separator 24. In other words, the separator 24 includes the electrolyte thereby allowing lithium ions to move between the positive and negative electrodes. The electrolyte includes a non-aqueous organic solvent and a lithium salt. The non-aqueous organic solvent serves as a medium for transmitting ions taking part in the electrochemical reaction of a battery. Advantageously, battery cell 20 can have a specific capacity of greater than 150 mAh/g. In a refinement, battery cell 20 has specific capacity greater than 190 mAh/g and typically, less than 250 mAh/g.

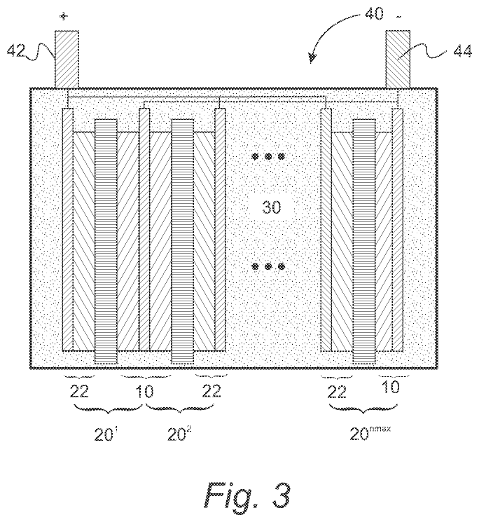

With reference to FIG. 3, a schematic of a rechargeable lithium-ion battery incorporating the negative electrode of FIG. 1 and the battery cells of FIG. 2 is provided. Rechargeable lithium-ion battery 40 includes at least one battery cell of the design in FIG. 2. Typically, comprising rechargeable lithium-ion battery 40 includes at least one battery cell 201 of the design of FIG. 2. Each lithium-ion battery cell 201 includes a negative electrode 10, which includes the compound represented by formula 1, a positive electrode 22 which includes a positive active material, and an electrolyte 30, where i is an integer label for each battery cell. The label i runs from 1 to nmax, where nmax is the total number of battery cells in rechargeable lithium-ion battery 40. The electrolyte 30 includes a non-aqueous organic solvent and a lithium salt. The non-aqueous organic solvent serves as a medium for transmitting ions taking part in the electrochemical reaction of a battery. The plurality of battery cells can be wired in series, in parallel, or a combination thereof. The voltage output from battery 40 is provided across terminals 42 and 44. Advantageously, rechargeable lithium-ion battery 40 can have a specific capacity of greater than 150 mAh/g for each battery cell therein.

Referring to FIGS. 2 and 3, separator 24 physically separates the positive electrode 22 from the negative electrode 10, thereby presenting shorting while allowing the transport of lithium ions for charging and discharging. Therefore, separator 24 can be composed of any material suitable for this purpose. Examples of suitable materials from which separator 24 can be composed include but are not limited to, polytetrafluoroethylene (e.g., TEFLON®), glass fiber, polyester, polyethylene, polypropylene, and combinations thereof. Separator 24 can be in the form of either a woven or non-woven fabric. Separator 24 can be in the form of a non-woven fabric or a woven fabric. For example, a polyolefin-based polymer separator such as polyethylene and/or polypropylene is typically used for a lithium-ion battery. In order to ensure heat resistance or mechanical strength, a coated separator includes a coating of ceramic or a polymer material may be used.

Referring to FIGS. 2 and 3, electrolyte 30 includes a lithium salt dissolved in the non-aqueous organic solvent. Therefore, electrolyte 30 includes lithium ions that can intercalate into the negative electrode active material during charging and into the anode active material during discharging. Examples of lithium salts include but are not limited to LiPF₆, LiBF₄, LiSbF₆, LiAsF₆, LiCAF₉SO₃, LiClO₄, LiAlO₂, LiAlCH₄, LICl, LiI, LIB(C₂O₄)₂, and combinations thereof. In a refinement, the electrolyte includes the lithium salt in an amount from about 0.1 M to about 2.0 M.

Still referring to FIGS. 2 and 3, the electrolyte includes a non-aqueous organic solvent and a lithium salt. Advantageously, the non-aqueous organic solvent serves as a medium for transmitting ions, and in particular, lithium ions participate in the electrochemical reaction of a battery. Suitable non-aqueous organic solvents include carbonate-based solvents, ester-based solvents, ether-based solvents, ketone-based solvents, alcohol-based solvents, aprotic solvents, and combinations thereof. Examples of carbonate-based solvents include but are not limited to dimethyl carbonate, diethyl carbonate, dipropyl carbonate, methylpropyl carbonate, ethylpropyl carbonate, methylethyl carbonate, ethylene carbonate, propylene carbonate, butylene carbonate, and combinations thereof. Examples of ester-based solvents include but are not limited to methyl acetate, ethyl acetate, n-propyl acetate, methylpropionate, ethylpropionate, γ-butyrolactone, decanolide, valerolactone, mevalonolactone, caprolactone, and combinations thereof. Examples of ether-based solvents include but are not limited to dibutyl ether, tetraglyme, diglyme, dimethoxyethane, 2-methyltetrahydrofuran, tetrahydrofuran, and the like, and the ketone-based solvent may include cyclohexanone, and the like. Examples of alcohol-based solvent include but are not limited to methanol, ethyl alcohol, n-propyl alcohol, isopropyl alcohol, and the like. Examples of the aprotic solvent include but are not limited to nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, sulfolanes, and the like. Advantageously, the non-aqueous organic solvent can be used singularly. In other variations, mixtures of the non-aqueous organic solvent can be used. Such mixtures are typically formulated to optimize battery performance. In a refinement, a carbonate-based solvent is prepared by mixing a cyclic carbonate and a linear carbonate. In a variation, electrolyte 30 can further include vinylene carbonate or an ethylene carbonate-based compound to increase e battery cycle life.

Referring to FIGS. 1, 2, and 3, the positive electrode and the negative electrode can be fabricated by methods known to those skilled in the art of lithium-ion batteries. Typically, an active material (e.g., the negative or positive active material) is mixed with a conductive material, and a binder in a solvent (e.g., N-methylpyrrolidone) into an active material composition and coating the composition on a current collector. The electrode manufacturing method is well known and thus is not described in detail in the present specification. The solvent includes N-methylpyrrolidone and the like but is not limited thereto.

Referring to FIGS. 1, 2, and 3, the positive electrode active layer 28 includes a positive electrode active material, a binder, and an optional conductive material. The binder can increase the binding properties of positive electrode active material particles with one another and with the positive electrode current collector 26. Examples of suitable binders include but are not limited to polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylate styrene-butadiene rubber, an epoxy resin, nylon, and the like, and combinations thereof. The conductive material provides positive electrode 10 with electrical conductivity. Examples of suitable electrically conductive materials include but are not limited to natural graphite, artificial graphite, carbon black, acetylene black, ketjen black, carbon fibers, copper, metal powders, metal fibers, and combinations thereof. Examples of metal powders and metal fibers are composed of including nickel, aluminum, silver, and the like.

Referring to FIGS. 1, 2, and 3, the negative active layer 12 includes a negative active material, includes a binder, and optionally a conductive material. The negative active materials used herein can be those negative materials known to one skilled in the art of lithium-ion batteries. Negative active materials include but are not limited to, carbon-based negative active materials, silicon-based negative active materials, and combinations thereof. A suitable carbon-based negative active material may include graphite and graphene. A suitable silicon-based negative active material may include at least one selected from silicon, silicon oxide, silicon oxide coated with conductive carbon on the surface, and silicon (Si) coated with conductive carbon on the surface. For example, silicon oxide can be described by the formula SiO_{z} where z is from 0.09 to 1.1. Mixtures of carbon-based negative active materials, and silicon-based negative active materials can also be used for the negative active material.

The negative electrode binder increases the binding properties of negative active material particles with one another and with a current collector. The binder can be a non-aqueous binder, an aqueous binder, or a combination thereof. Examples of non-aqueous binder may be polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof. Aqueous binders can be rubber-based binders or polymer resin binders. Examples of rubber-based binders include but are not limited to styrene-butadiene rubbers, acrylated styrene-butadiene rubbers, acrylonitrile-butadiene rubbers, acrylic rubbers, butyl rubbers, fluorine rubbers, and combinations thereof. Examples of polymer resin binders include but are not limited to polyethylene, polypropylene, ethylenepropylene copolymer, polyethyleneoxide, polyvinylpyrrolidone, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and combinations thereof.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A negative electrode for a rechargeable lithium-ion battery, the negative electrode comprising:
a negative electrode current collector
a negative electrode active layer disposed over the negative electrode current collector, the negative electrode active layer being composed of negative electrode active material; and
a ceramic particle-containing layer disposed over the negative electrode active layer, the ceramic particle-containing layer being composed of ceramic particles and a thermoset binder, the thermoset binder being composed of residues of cross-linkable monomers.

2. The negative electrode of claim 1, wherein the cross-linkable monomers include multi-functional moieties.

3. The negative electrode of claim 1, wherein the thermoset binder is composed of a component selected from the group consisting of acrylic polymers, vinylic polymers, epoxy polymers, urethane, fluoropolymers, polyesters, polyimides, epoxy resins, phenolic resins, polyurethanes, unsaturated polyester resins, melamine formaldehyde resins, silicone resins, and combinations thereof.

4. The negative electrode of claim 1, wherein the ceramic particle-containing layer has a thickness from about 0.1 microns to about 30 microns.

5. The negative electrode of claim 1, wherein the ceramic particle-containing layer has a thickness from about 0.3 microns to about 10 microns.

6. The negative electrode of claim 1, wherein the ceramic particles include particles selected from the group consisting of barium titanate, alumina, boehmite, zirconia, magnesia, boron nitride, silicon carbide, titania, silica, and combinations thereof.

7. The negative electrode of claim 1, wherein the ceramic particles have an average size from about 0.1 micron and 10 microns.

8. The negative electrode of claim 1, wherein the ceramic particles have an average size from about 0.2 microns to 2 microns.

9. The negative electrode of claim 1, wherein the ceramic particles are present in an amount from about 80 weight percent to about 99.9 weight percent of the combined weight of the ceramic particles and the thermoset binder and the thermoset binder is present in an amount from about 0.1 weight percent to about 20 weight percent of the combined weight of the ceramic particles.

10. The negative electrode of claim 1, wherein the negative active material is a carbon-based negative active material, a silicon-based negative active material, or a combination thereof.

11. A rechargeable lithium-ion battery comprising at least one lithium-ion battery cell, each lithium-ion battery cell including:
a negative electrode comprising:
a negative electrode current collector
a negative electrode active layer disposed over the negative electrode current collector, the negative electrode active layer being composed of negative electrode active material; and
a ceramic particle-containing layer disposed over the negative electrode active layer, the ceramic particle-containing layer being composed of ceramic particles and a thermoset binder, the thermoset binder being composed of residues of cross-linkable monomers;
a positive electrode including a positive active material; and
an electrolyte contacting the negative electrode and the positive electrode.

12. The rechargeable lithium-ion battery of claim 11, wherein each lithium-ion battery cell further includes a separator interposed between the negative electrode and the positive electrode.

13. The rechargeable lithium-ion battery of claim 11, wherein the thermoset binder is composed of a component selected from the group consisting of acrylic polymers, vinylic polymers, epoxy polymers, urethane, fluoropolymers, polyesters, polyimides, and a combination thereof.

14. The rechargeable lithium-ion battery of claim 11, wherein the ceramic particle-containing layer has a thickness from about 0.1 microns to about 30 microns.

15. The rechargeable lithium-ion battery of claim 11, wherein the ceramic particles include particles selected from the group consisting of BaTiO₃, alumina, boehmite, zirconia, magnesia, boron nitride, silicon carbide, titania, silica, and combinations thereof.

16. The rechargeable lithium-ion battery of claim 11, wherein the ceramic particles have an average size from about 0.1 micron and 10 microns.

17. The negative electrode of claim 11, wherein the ceramic particles have an average size from about 0.2 microns to 2 microns.

18. The negative electrode of claim 11, wherein the ceramic particles are present in an amount from about 0.1 weight percent to about 20 weight percent of the combined weight of the ceramic particles and the thermoset binder and the thermoset binder is present in an amount from about 99.9 weight percent to about 80 weight percent of the combined weight of the ceramic particles.

19. A method for making a negative electrode comprising:
preparing a negative active material composition by mixing a negative electrode active material, a binder, and a solvent;
coating a negative electrode current collector with the negative active material composition to form an uncured negative electrode active layer;
curing and/or drying the uncured negative electrode active layer to form a cured negative electrode active layer;
forming a reactive mixture that includes ceramic particles and cross-linkable monomers;
coating the cured negative electrode active layer with the reactive mixture to form a thermoset ceramic layer; and
curing the thermoset ceramic layer to form a ceramic particle-containing layer.

20. The method of claim 19, wherein the reactive mixture further a radical initiator.
